(19) United States
(12) Patent Application Publication
(10) Pub. No.: US 2007/0033314 A1
(43) Pub. Date: Feb. 8, 2007

(54) Event generation for device hotplug

(76) Inventors: Arad Rostampour, Fort Collins, CO (US); Paul Bouchier, Little Elm, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/189,865

(22) Filed: Aug. 4, 2005

(51) Int. Cl. G06F 13/00

(52) U.S. Cl. 710/302

(57) ABSTRACT

A computer-implemented method is disclosed for use in a computer system. In one embodiment, the method includes: (A) receiving from a user an instruction to perform a hotplug operation on a device in the computer system; and (B) in response to the instruction, using a manageability processor in the computer system to transmit to an operating system executing in the computer system an event indicating the hotplug operation to perform on the device.

### CROSS REFERENCE TO RELATED APPLICATIONS

This application is related to a concurrently-filed and commonly-owned U.S. patent application entitled, “Supporting Multiple Methods for Device Hotplug in a Single Computer,” which is hereby incorporated by reference.

### BACKGROUND

Computers often contain internal devices, such as network cards and storage cards, that may be detached from the I/O bus to which they are connected. For example, if a device malfunctions, it may be necessary to detach the device from the bus and to attach a new device to the bus. Similarly, it may be desirable to detach a device from the bus to replace the device with a different, superior, device.

Detaching a device from the I/O bus of an older computer system while the computer system was running would cause serious damage to the computer system. As a result, detaching a device from such a system required powering down the system, detaching the device (and replacing it with a new device, if appropriate), and powering up the system again. This was tedious and time-consuming. Furthermore, the computer system could not be used for other functions (such as running application programs that did not require the detached device) while it was powered down. This would decrease both the productivity of the computer's users and the overall system uptime. If the computer was a server or other computer that was required for use by multiple users simultaneously, detaching a single device from the computer could disrupt the work being performed by all of those users.

As a result, techniques were developed which made it possible to detach and attach devices to a computer system while the system was running. This ability is referred to as “hotplugging” or “hotswapping” to indicate that the computer is “hot” (powered on) while devices are added to and removed from it. Systems that support hotplugging may include related multi-path features that allow device requests to be rerouted to a second device that connects to the same path, while the first device is being replaced or removed.

ACPI (Advanced Configuration and Power Interface) is an open industry specification that is one example of a technology for facilitating hotplugging. ACPI defines a variety of firmware, hardware, and operating system interfaces for accomplishing system configuration, power management, plug 'n play, and a variety of other system-specific behaviors. For example, ACPI defines interfaces for performing hotplug of devices connected to PCI buses.

In some computer systems, a physical switch known as a “doorbell” is situated near each device for which hotplugging is enabled. To physically remove a device from such a computer system, the user presses the device's doorbell. In systems implementing ACPI, pressing the doorbell causes the computer's hardware to transmit a hardware event (referred to as a General Purpose Event or GPE) to the operating system executing on the computer, indicating that the user desires to remove the device. In response to receiving the event, the operating system executes a firmware method that prepares the device to be removed (such as by notifying the device driver that the device is about to be removed). A physical switch known as a “latch” may also be situated near the device. To remove the device, the user must open the latch, causing power to the device to be turned off before the device is removed. The latch may also cause a GPE to be transmitted to the operating system, or may simply operate as an electrical switch to turn off power to the device. The doorbell and latch operate in reverse of the order described above when a user attaches a device to the computer system.

Some computers do not have doorbells and latches. It is desirable to provide such computers with the ability to perform hotplug operations without the use of a doorbell or latch.

### SUMMARY

A computer-implemented method is disclosed for use in a computer system. In one embodiment, the method includes: (A) receiving from a user an instruction to perform a hotplug operation on a device in the computer system; and (B) in response to the instruction, using a manageability processor in the computer system to transmit to an operating system executing in the computer system an event indicating the hotplug operation to perform on the device.

### BRIEF DESCRIPTION OF THE DRAWINGS

FIG. 1A is a block diagram of the architectural layers of one embodiment of a computer system;

FIG. 1B is a block diagram of the cells and partitions of the computer system of FIG. 1A in one embodiment;

FIG. 2 is a dataflow diagram illustrating the actions performed by the computer system to perform a hotplug operation in one embodiment;

FIG. 3 is a flowchart of a method that is performed by the computer system of FIG. 2 in one embodiment; and

FIG. 4 is a diagram illustrating a sequence of interactions between the user and the manageability interface of FIG. 2 to perform a hotplug in one embodiment.

### DETAILED DESCRIPTION

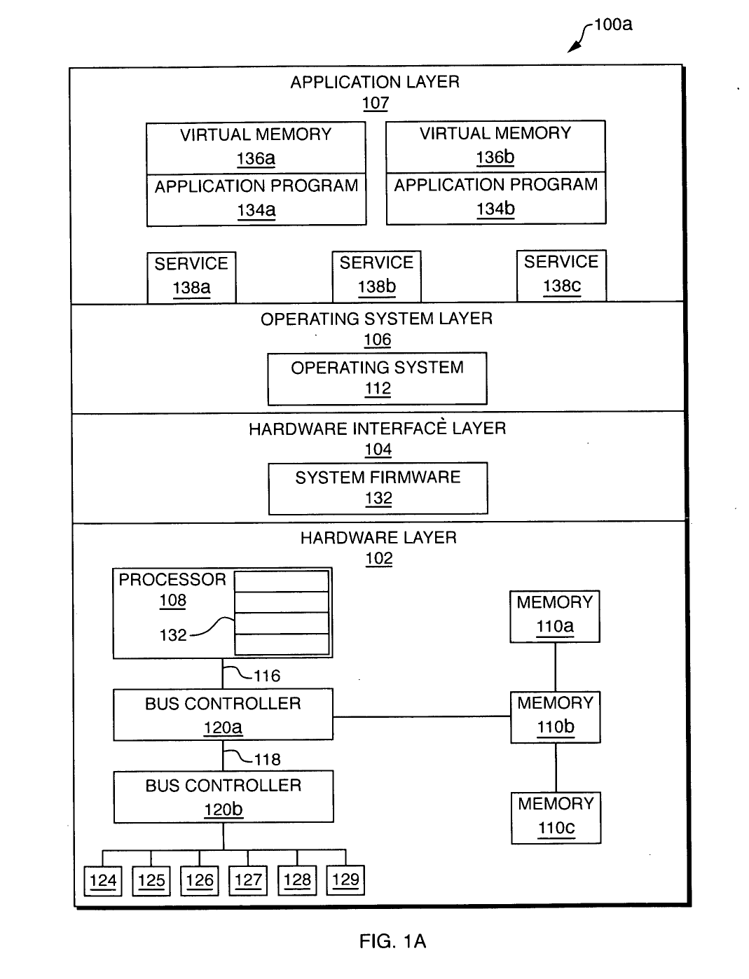

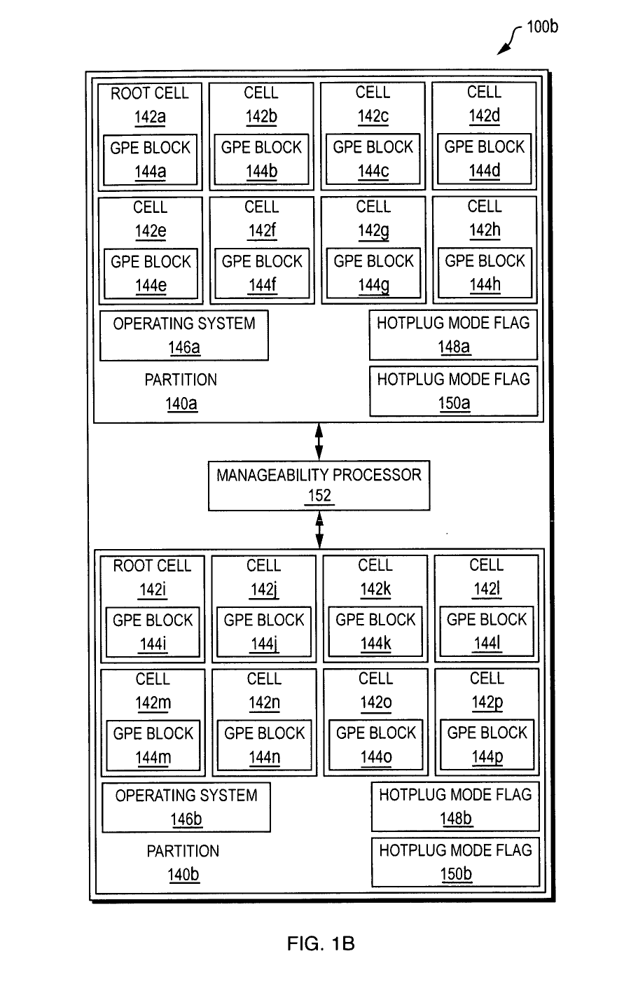

Referring to FIG. 1, a block diagram is shown of one embodiment of a computer system 100. The computer system 100 includes a hardware layer 102, a hardware interface layer 104, an operating system layer 106, and an application program layer 107. The operating system and application programs in the computer system 100 execute on hardware in the hardware layer 102. The “layers” 104, 106, and 107 illustrated in FIG. 1 do not, therefore, represent physical layers of components which are physically layered on top of the hardware layer 102. Rather, the computer system 100 is illustrated as consisting of layers 102, 104, 106, and 107 as an aid to explaining the interactions among hardware and software in the computer system 100. In particular, it is common to conceptualize and illustrate computer systems in terms of such layers to highlight the dependence of elements at a higher layer on elements at lower layers, and to illustrate the flow of control and data among layers.

The hardware layer 102 comprises the physical components of the computer system 100. Such physical components may include, for example, a processor 108, memory storage components 110a-c, internal buses and signal lines 116-119, bus controllers 120a-b, and various peripheral interface cards 124-129. The processor 108 is an instruction-execution device that executes a stream of instructions obtained from memory components 110a-c. The processor 108 contains internal memory storage components referred to as registers 130 that can be accessed much more quickly than the memory components 110a-c. The processor 108 reads and writes data and instructions from and to the memory components 110a-c via internal buses 116 and 117 and the bus controller 120a. Far greater data storage capacity resides in peripheral data storage devices such as disk drives, CD-ROM drives, DVD drives, and other such components that are accessed by the processor 108 via internal buses 116, 118, and 119, bus controllers 120a-b, and one or more of the peripheral device interconnect cards 124-129. For example, the stored instructions of a large program may reside on a disk drive for retrieval and storage in memory components 110a-c on an as-needed basis during execution of the program. More sophisticated computers may include multiple processors with correspondingly more complex internal bus interconnections and additional components.

The operating system layer 106 is a logical layer which includes a software program 112 referred to as an operating system, which is capable of controlling the hardware components in the hardware layer 102. Modern operating systems are relatively large and complex, typically consisting of a large number of sub-programs executing concurrently. At its core, however, the operating system 112 includes program code which may be utilized by application programs to cause the hardware components in the hardware layer 102 to perform functions such as reading from and writing to memory and peripheral devices.

The hardware interface layer 104, as its name suggests, acts as an interface between the operating system layer 106 and the hardware layer 102. The hardware interface layer 104 may include hardware, software, firmware, or any combination thereof. One purpose of the hardware interface layer 104 may be to provide a single abstract interface through which the operating system layer 106 may communicate with the processor 108 and other components in the hardware layer 102, regardless of the particular manner in which such components are implemented.

The hardware interface layer 104 may include system firmware 132. The system firmware 132 performs functions such as writing and reading the values of system-wide parameters.

The application layer 107 includes one or more application programs. Two application programs 134a-b are illustrated in FIG. 1 for ease of illustration and explanation. The operating system 112 allocates virtual memory regions 136a-b to application programs 134a-b, respectively. Requests by the application programs 134a-b to access the corresponding virtual memory regions 136a-b are passed through the operating system 112, which performs the requested read/write operation on the appropriate location(s) in the memory components 110a-c.

Referring to FIG. 1B, a block diagram is shown of a different view 100b of the computer system 100a illustrated in FIG. 1A. The views 100a and 100b shown in FIGS. 1A and 1B may be referred to herein collectively as “the computer system 100.” FIG. 1B depicts the computer system 100 not in terms of a series of layers, but instead in terms of a plurality of cells 142a-p logically grouped into partitions 140a-b. More specifically, there are sixteen cells 142a-p, logically subdivided into two partitions 140a-b of eight cells each. These particular numbers and distributions of cells and partitions are provided merely for purpose of example.

Note that for ease of illustration and explanation, FIG. 1A illustrates only a subset of the computer system 100. For example, the hardware layer 102 shown in FIG. 1A includes the hardware typically provided in a single one of the cells 142a-p shown in FIG. 1B. The computer system 100b as illustrated in FIG. 1B, therefore, includes a plurality of hardware layers, one for each of the cells 142a-p. Similarly, the operating system layer 106 shown in FIG. 1A corresponds to one of the operating systems 146a-b shown in FIG. 1B. The computer system 100b as illustrated in FIG. 1B, therefore, includes a plurality of operating systems 146a-b, one for each of the partitions 140a-b.

The computer system 100b also includes a manageability processor 152. A manageability processor is a processor commonly used in servers to perform system management functions such as booting up the server with an appropriate operating system and configuring the PCI configuration space. As will be described in more detail below, the manageability processor 152 is not contained within any particular partition or cell and can provide services across cells and partitions.

The 16-cell computer system 100b shown in FIG. 1B may, for example, be logically divided into two or more logical partitions, each of which may contain one or more cells. In the example shown in FIG. 1B, the computer system 100b is logically subdivided into two partitions 140a-b, each of which contains eight cells. Each of these partitions 140a-b aggregates the computing resources of its cells and provides the behavior of a distinct computer system. For example, partition 140a executes operating system 146a on the cells 142a-h, while partition 140b executes a second operating system 146b on the cells 142i-p. Techniques for implementing multi-cell, multi-partition computer systems are well-known to those having ordinary skill in the art, and will therefore not be described in detail herein.

Examples of techniques will now be described for performing a hotplug operation in the computer system 100. As will be described in more detail below, such techniques enable a hotplug operation to be performed even if the computer system 100 does not include any mechanical doorbells or latches. Instead of using such mechanical doorbells or latches to trigger the transmission of the required hotplug event to the operating system 112, the techniques disclosed herein use the manageability processor 152 to generate the required hotplug event in response to a command 220 provided by a user 208 through a soft interface. As used herein, the term “soft interface” refers to an interface provided by software and/or firmware, in contrast to the hardware interface provided by a physical doorbell or latch. The user may, for example, connect to a soft interface remotely via a terminal session or telnet and then interact with it using a device that is not connected to the local system bus. The user may, for example, interact with a soft interface using a keyboard, mouse, monitor, or other peripheral device(s) connected rather than using a direct mechanical connection such as a physical doorbell or latch.

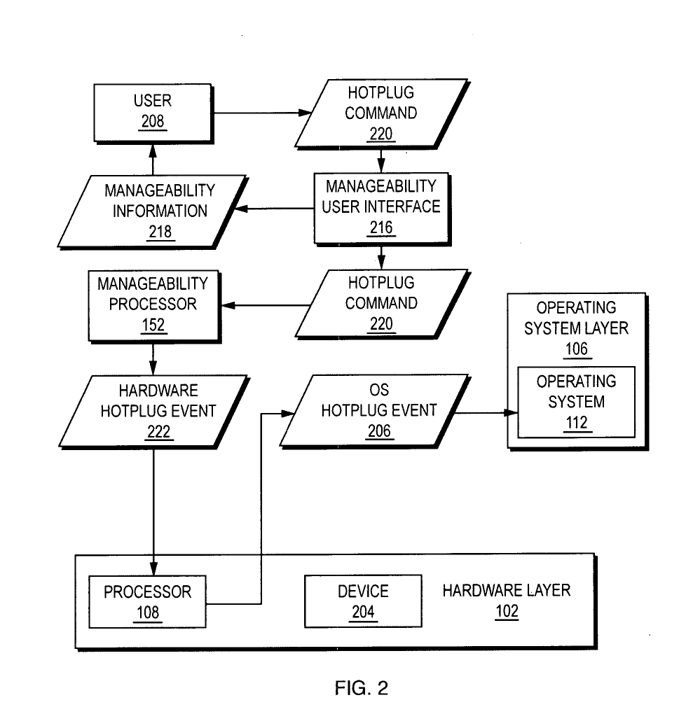

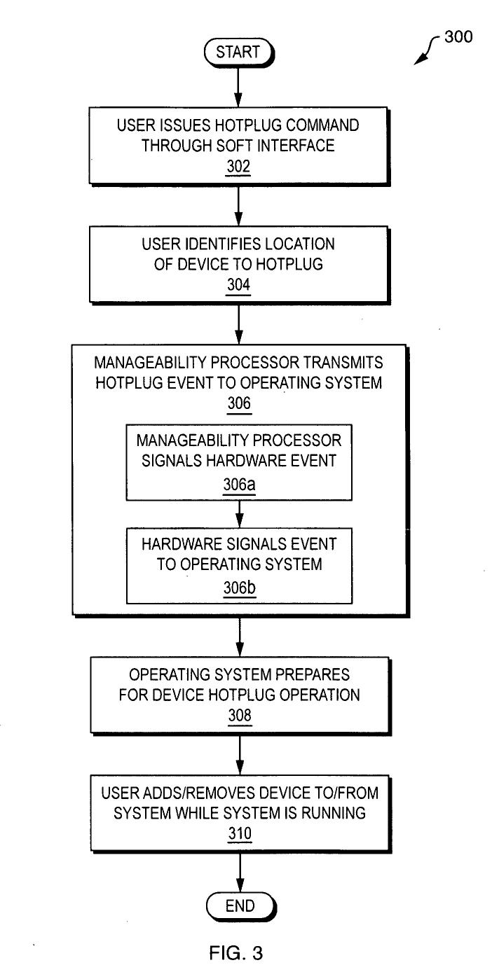

Referring to FIG. 2, a dataflow diagram is shown illustrating the actions performed by the computer system 100 to perform a hotplug operation in one embodiment. Referring to FIG. 3, a flowchart is shown of a method 300 that is performed by the computer system 100 in FIG. 2 in one embodiment. As used herein, to “perform a hotplug operation” means to add or remove a device from a computer system while the computer system is running.

Upon powering up the computer system 100, the manageability processor 152 may present the user 208 with a manageability user interface (UI) 216. In general, the user 208 may provide commands 220 to the manageability processor 152 through the manageability UI 216, in response to which the manageability processor 152 may execute the commands 220. The manageability processor 152 may provide information 218 to the user 208 through the manageability user interface 216.

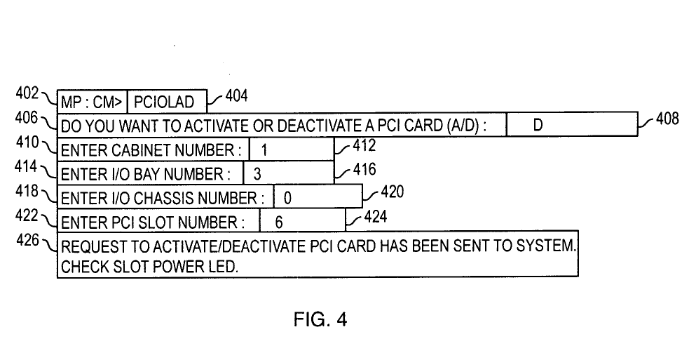

The manageability UI 216 may, for example, be a simple command line interface through which the user 208 may type textual commands. For example, referring to FIG. 4, a diagram is shown illustrating a sequence of interactions between the user 208 and the manageability interface 216 to perform a hotplug in one embodiment. Note that the particular prompts and commands shown in FIG. 4 are merely examples and may be implemented in other ways.

If the user 208 desires to add a device to or remove a device from the computer system 100, the user 208 may provide an appropriate command 220, referred to herein as a “hotplug command,” to the manageability interface 216 (FIG. 3, step 302). In the example shown in FIG. 4, the manageability user interface provides a command prompt 402 to the user 208, in response to which the user 208 types the command “PCIOLAD” 404 to indicate his desire to perform a hotplug on a device. The acronym “PCIOLAD” stands for PCI online addition and deletion.

Upon receiving the hotplug command 404, the manageability interface 216 provides the user 208 with a prompt 406 asking whether the user 208 desires to activate (i.e., add) or deactivate (i.e., remove) a device. The user 208 issues a command indicating his preference. In the example illustrated in FIG. 4, the user types “D” 408 to indicate that he desires to deactivate a device. The combination of the command “PCIOLAD” 404 and the selection “D” 408 is an example of the hotplug command 220 shown in FIG. 4.

As used herein, the term “complex” refers to a relatively large computer system that is capable of being logically subdivided into multiple partitions. A complex may, for example, have multiple cabinets, each of which may have multiple cells, each of which may be connected to an I/O bay, each of which may have multiple chasses, each of which may include one or more PCI slots. One way to unambiguously identify a single PCI slot in such a machine, therefore, is to identify the cabinet number, I/O bay number, I/O chassis #, and PCI slot number.

The manageability interface 216 prompts 410 the user 208 for the cabinet number of the device to remove or add, in response to which the user 208 provides the cabinet number 412. The manageability interface 216 prompts 414 the user 208 for the I/O bay number the device is in (or will be installed in), in response to which the user 208 provides the I/O bay number 416. The manageability interface 216 prompts 418 the user 208 for the I/O chassis number the device is in (or will be installed in), in response to which the user 208 provides 420 the I/O chassis number. Finally, the manageability interface 216 prompts 422 the user 208 for the PCI slot number the device is in (or will be installed in), in response to which the user 208 provides 424 a PCI slot number. By providing these various pieces of information about the device to add or remove, the user 208 unambiguously identifies the location of the device to hotplug (FIG. 3, step 304).

Note that the manageability interface 216 may allow the user 208 to identify the device in other ways. For example, in a multi-partition system, the manageability interface 216 may allow the user to identify the device by its partition number and PCI slot number. And in a non-partitioned system, slot number alone may be sufficient.

Once the user 208 has identified the location of the device to hotplug, the manageability processor 152 generates a “hotplug event” 206 and transmits the event 206 to the operating system 112 (step 306). As will be described in more detail below, the manageability processor 152 transmits the hotplug event 206 indirectly, by first transmitting hardware event 222 to the processor 108, which in turn generates and transmits hotplug event 206 to the operating system 112. The term “hotplug event” refers herein to an event that informs the operating system 112 of a hotplug to be performed. A hotplug event specifies, for example, the hotplug operation to be performed (e.g., add or remove) and the location of the device to be hotplugged (using, for example, the information provided by the user 208 in step 304). In ACPI-compliant systems, the hotplug event 206 transmitted in step 306 may be implemented as a specific general purpose event (GPE) that is tied to either an add or delete action for a specific slot.

The hotplug event 206 generated in step 306 may, for example, be the same kind of event as would be generated in response to the user 208 pressing a physical doorbell in the computer system 100. As a result, the hotplug event 206 is equivalent to and therefore indistinguishable, from the point of view of the operating system 112, from a conventional hotplug event generated in response to pressing a physical doorbell. One benefit of the techniques illustrated in FIGS. 2 and 3, therefore, is that the operating system 112 may be a conventional operating system and need not be modified to work in conjunction with such techniques. Only the manageability processor 152 need be configured to interact with the user 208 and provide the hotplug event to the operating system 112 in the manner described herein.

The hotplug event 206 may be generated in any of a variety of ways. For example, in one embodiment, the manageability processor 152 transmits an event to the ACPI core (not shown), which in turn causes an ACPI interrupt 222 to be signaled to the processor 108 (step 306a). In response, the processor 108 executes ACPI interrupt service code that signals 206 the operating system 112 to execute the ACPI method associated with the hotplug event 222 (step 306b).

In response to receiving the hotplug event 206, the operating system 112 executes a firmware method that prepares the device to be removed (step 308). The execution of such a method is part of the ACPI specification and techniques for implementing such methods are well-known to those having ordinary skill in the art.

The user 208 may then perform the desired hotplug operation by adding the desired device 204 to or removing the desired device 204 from the computer system 100 while the computer system 100 is running (step 310).

The techniques just described therefore enable the user 208 to perform a hotplug operation on device 204 without the use of a physical doorbell or latch. The sequence of events described above implement a virtual doorbell and latch, because they perform the same function as a physical doorbell and latch without the actual use of a physical doorbell and latch.

Among the advantages of the invention are one or more of the following. The ability to initiate a hotplug event in response to a command provided by a user through the manageability interface 104 (or other software or firmware interface) enables hotplug operations to be performed even on computer systems lacking physical doorbells and latches. The techniques disclosed herein therefore bring the benefits of hotplugging to such computer systems.

Furthermore, the techniques disclosed herein may be implemented in a computer system without modifying the operating system of the computer system, assuming that the operating system already supports hotplug operations, such as via a standard ACPI mechanism. Rather, it is only necessary that some component or components of the computer system (such as the manageability processor 152) be provided with the ability to receive a hotplug command from the user and to provide a hotplug event to the operating system 112 in response to the hotplug command. Because such functionality may be provided in software and/or firmware rather than hardware, it is typically less expensive to design and implement such features than it would be to add physical doorbells and latches, and the associated circuitry, to such systems. The techniques disclosed herein therefore enable computer systems to be equipped with hotplugging capabilities at lower cost than using conventional physical doorbells and latches.

Furthermore, the techniques disclosed herein may enable the user 208 to perform hotplugging more easily than in conventional systems. The manageability interface 104 may provide the user 208 with an interface that is more user-friendly than that provided by physical doorbells and latches. The manageability interface 104 may, for example, step the user 208 through the process of performing a hotplug operation, provide the user with additional information about the operation, and inform the user of any problems that occur during the operation. The techniques disclosed herein may thereby facilitate the process of adding and removing devices from the computer system.

In addition, the techniques disclosed herein may be used to generate hotplug events in partitionable computer systems. Because the user fully specifies the location of the device that is to be added/removed from the computer system 100, the manageability processor 152 may generate a hotplug event that unambiguously identifies the device within its partition.

Furthermore, the techniques disclosed herein simplify the implementation of hotplug events in partitionable computer systems. In such a system, the hardware may be logically subdivided into multiple partitions, each of which may include multiple cells, each of which may include multiple chasses, each of which may include multiple I/O slots. Centralizing the handling of hotplug events in the manageability processor 152 allows the system to avoid the need to perform complicated routing of hotplug events within such a computer system.

In addition, the techniques disclosed herein enable a hotplug to be signaled remotely. For example, it may be possible to communicate with the manageability processor 152 over a network connection. In contrast, conventional doorbells and latches can only be manipulated locally by physically manipulating them. Remote control of the manageability processor provides greater flexibility to the system administrator in configuring the computer system.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Although certain functions are described herein as being performed by the manageability processor 152 and the associated manageability interface 216, this is not required. Rather, such functions may be performed by other components, whether in hardware, software, firmware, or any combination thereof.

Although a particular user interface is shown and described herein with respect to FIG. 4, this user interface is merely an example. Other user interfaces may be used to interact with the user 208, including both textual and graphical user interfaces. Such user interfaces constitute “soft” user interfaces if, for example, they provide information to the user 208 through a display screen and/or if they receive instructions from the user 208 through a peripheral device (such as a keyboard or mouse) rather than through a mechanical switch (such as a physical doorbell or latch).

The term “hotplug” is used generically herein to refer to the act of adding or removing a device from a computer system while the computer system is running. Similarly, the term “hotplug command” is used to refer generically to any instruction provided by the user 208 to perform a hotplug. In a particular situation, the user may provide a command specifically to add a device a command specifically to remove a device, or a command specifically to replace a device. Each such command is an example of a “hotplug command.”

Various terms are used herein to refer to installing a device in a computer system, and should all be considered to have the same meaning herein: “add,” “install,” “insert,” and “activate.” Similarly, various terms are used herein to refer to uninstalling a device from a computer system, and should all be considered to have the same meaning herein: “remove,” “de-install,” “uninstall,” “eject,” and “deactivate.”

Although certain examples herein refer to PCI buses and devices connected to such buses, this is merely an example. The techniques disclosed herein may be used in conjunction with any kind of bus and device. Similarly, although certain examples herein refer to particular operating systems (such as the Microsoft Windows family of operating systems), these are merely examples. The techniques disclosed herein may be used in conjunction with any kind of operating system.

Although the techniques disclosed herein may have certain advantages in comparison to using physical doorbells and latches to perform hotplug operations, the techniques disclosed herein may be used in systems having physical doorbells and latches. In such a case, the user may, for example, choose whether to perform a hotplug operation using the techniques disclosed herein or using physical doorbells and latches.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. In a computer system, a computer-implemented method comprising:
(A) receiving from a user an instruction to perform a hotplug operation on a device in the computer system;
(B) in response to the instruction, using a manageability processor in the computer system to transmit to an operating system executing in the computer system an event indicating the hotplug operation to perform on the device.

2. The method of claim 1, wherein the instruction comprises an instruction to remove the device from the computer system.

3. The method of claim 1, wherein the instruction comprises an instruction to add the device to the computer system.

4. The method of claim 1, wherein the instruction comprises an instruction to replace the device with another device in the computer system.

5. The method of claim 1, wherein (A) comprises receiving the instruction through a peripheral device coupled to a system bus in the computer system.

6. The method of claim 1, wherein (A) comprises receiving the instruction using a soft user interface.

7. The method of claim 1, wherein (A) is performed by the manageability processor.

8. The method of claim 1, further comprising:
(C) performing the hotplug operation on the device.

9. The method of claim 1, wherein (A) comprises receiving the instruction from the user over a network connection.

10. The method of claim 1, wherein the computer system includes a doorbell and means for generating a doorbell event in response to operation of the doorbell, and wherein (B) comprises transmitting to the operating system an event equivalent to the doorbell event.

11. The method of claim 10, wherein the operating system supports ACPI (Advanced Configuration and Power Interface), wherein the doorbell event is an ACPI general purpose event (GPE), and wherein (B) comprises transmitting an ACPI GPE that is equivalent to the doorbell event.

12. The method of claim 1, further comprising:
(C) in response to the event, using the operating system to execute a process associated with the event.

13. In a computer system, an apparatus comprising:
means for receiving from a user an instruction to perform a hotplug operation on a device in the computer system;
means for using a manageability processor in the computer system to transmit to an operating system executing in the computer system an event indicating the hotplug operation to perform on the device.

14. The apparatus of claim 13, wherein the means for receiving comprises means for receiving the instruction through a peripheral device coupled to a system bus in the computer system.

15. The apparatus of claim 13, wherein the means for receiving comprises means for receiving the instruction using a soft user interface.

16. The apparatus of claim 13, wherein the means for receiving comprises the manageability processor.

17. The apparatus of claim 13, further comprising:
means for performing the hotplug operation on the device.

18. The apparatus of claim 13, wherein the means for receiving comprises means for receiving the instruction from the user over a network connection.

19. The apparatus of claim 13, wherein the computer system includes a doorbell and means for generating a doorbell event in response to operation of the doorbell, and wherein the means for using the manageability processor comprises means for transmitting to the operating system an event equivalent to the doorbell event.

20. The apparatus of claim 13, further comprising:
means for using the operating system to execute a process associated with the event.

21. A computer system comprising a manageability processor, the manageability processor comprising:
a manageability user interface to receive from a user an instruction to perform a hotplug operation on a device in the computer system;
means for transmitting to an operating system executing in the computer system an event indicating the hotplug operation to perform on the device.

22. The computer system of claim 21, wherein the manageability user interface comprises means for receiving the instruction through a peripheral device coupled to a system bus in the computer system.

23. The computer system of claim 21, wherein the manageability user interface comprises a soft user interface and wherein the means for receiving comprises means for receiving the instruction through the soft user interface.

24. The computer system of claim 21, further comprising:
an operating system to perform the hotplug operation on the device.

25. The computer system of claim 21, wherein the means for receiving comprises means for receiving the instruction from the user over a network connection.

26. The computer system of claim 21, further comprising:
a doorbell; and
means for generating a doorbell event in response to operation of the doorbell;
wherein the manageability processor comprises means for transmitting to the operating system an event equivalent to the doorbell event.

27. The computer system of claim 21, wherein the operating system comprises means for executing a process associated with the event.
